(19) United States
(12) Patent Application Publication
(10) Pub. No.: US 2014/0212112 A1
(43) Pub. Date: Jul. 31, 2014

(54) CONTACT VIDEO GENERATION SYSTEM

(71) Applicants: Olle Håff, Umea (SE); Fredrik Johansson, Malmo (SE)

(72) Inventors: Olle Håff, Umea (SE); Fredrik Johansson, Malmo (SE)

(73) Assignee: SONY MOBILE COMMUNICATIONS AB, Lund (SE)

(21) Appl. No.: 14/237,110

(22) PCT Filed: Aug. 4, 2011
(86) PCT No.: PCT/IB2011/053492

§ 371 Date: Feb. 4, 2014

(51) Int. Cl. G11B 27/02

(52) U.S. Cl. CPC G11B 27/02
USPC 386/286

(57) ABSTRACT

A system and method for generation of video relevant to the subject of a contact record in a mobile device phonebook or contacts list. The method may include aggregating a plurality of data files originating from at least one data source, where at least some of the data bears a relationship to the subject of the contact record. A predefined template of instructions is provided for incorporation of data into the video, and the data is merged into a video according to the predefined template. Aggregating the plurality of data files may include searching data files accessed from a plurality of data sources using predetermined searching criteria, and retrieving the data files. Data sources may include any or all of a social media network, a social graph, a non-username, non-password protected website, and a datastore local to the mobile device. The video may be stored or rendered in real-time.

### FIELD

Embodiments described herein relate generally to contact records in mobile devices, and more particularly to descriptive information about the subjects of the contact records.

### BACKGROUND

The Social Graph, related content, and relationships between each other are becoming increasingly important when it comes to defining a person. The Internet in general as well as other applications available on mobile devices also present resources for information related to people. Conventional mobile devices are usually limited to describing a person by name, contact information that may include phone numbers, email addresses, and physical addresses, and, in most advanced cases, a photo. One tangible example of this is the phonebook or contacts list, where a person or other entity is described in a contact record by only this small set of attributes. While functional, this limited information does not tell very much about, for example, the person, how they are known, history of the relationship, their friends, family, location, current status, and so forth. In addition, such conventional displays of information may be considered relatively uninteresting.

### SUMMARY

In accordance with one embodiment of the present invention, a method for generating a video related to a subject of a contact record in a mobile device is provided. The method includes aggregating a first plurality of data files originating from at least one data source. At least some of the data in the data files bears a relationship to the subject of the contact record. A predefined template for incorporation of data into the video is provided, and the data is merged into a video according to the predefined template. In some embodiments, the method includes saving the video as a video stream file for later rendering, and then may include accessing the video stream file and rendering the video in the mobile device. In other embodiments, the method includes rendering the video in the mobile device in real time as the data is merged into the video.

In some embodiments, the method includes rendering the video in the mobile device when the contact record is accessed, while in other embodiments the method includes rendering the video in the mobile device after the contact record is accessed and when a user instructs the video to be rendered.

In some embodiments, the method includes, in advance of aggregating the first plurality of data files, prompting a user to provide input to identify a subject of the video based on either selecting from existing contact records or creating a new contact record. Then the user's input is received.

In some embodiments, at least one of aggregating a plurality of first data files, providing a template, and merging data is performed in the mobile device, and in some embodiments, at least one of such actions is performed in a server remote from the mobile device. In some embodiments, the at least one data source includes at least one of a social media network, a social graph, a non-username, non-password protected website, a datastore local to the mobile device, or a combination thereof

In some embodiments, aggregating the first plurality of data files further includes searching a second plurality of data files accessed from at least one data source using predetermined searching criteria that bear a relationship to the subject of the contact record. One or more data files are retrieved based on the search. In some such embodiments, the data files represent a plurality of data types, and the types of data may include text, photo, audio, video, or a combination thereof. In some embodiments, the first plurality of data files originates from at least one data source comprising at least one datastore including a contact record profile, email, SMS, photo files, music files, or a combination thereof. In some embodiments, aggregating the plurality of data files further includes storing the retrieved data files.

In some embodiments, the predefined template includes associated instructions for incorporation of data into the video including instructions for the order of the data files of the plurality of data types to be incorporated in the video and the duration of play of each data file in the video. In some such embodiments, the instructions for incorporation of data into the video further include (1) instructions for rendering a plurality of data files concurrently, and/or (2) instructions for transitions between data files in the video.

In some embodiments, the method includes storing the video in a local datastore in the mobile device, while in other embodiments the method includes storing the video in a datastore on a server.

In accordance with another embodiment of the present inventions, a contact video generation system is provided including a processing device. The processing device is configured for aggregating a first plurality of data files originating from at least one data source. At least some of the data in the data files bears a relationship to the subject of the contact record. The processing device is further configured for providing a predefined template of instructions for incorporation of data into the video, and for merging data into a video according to the predefined template.

In some embodiments, the processing device is further configured for saving the video as a video stream file for later rendering, and then for accessing the video stream file and rendering the video in the mobile device. In other embodiments, the processing device is configured for rendering the video in the mobile device in real time as the data is merged into the video.

In some embodiments, the processing device is further configured for rendering the video in the mobile device when the contact record is accessed, while in other embodiments, the processing device is further configured for rendering the video in the mobile device after the contact record is accessed and when a user instructs the video to be rendered.

In some embodiments, the processing device is further configured for, in advance of aggregating a plurality of data files, (1) prompting a user to provide input to identify a subject of the video based on either selecting from existing contact records or creating a new contact record, and (2) receiving the user's input. In some embodiments, the processing device is in the mobile device, while in other embodiments the processing device is in a server remote from the mobile device.

In some embodiments, the at least one data source includes at least one of a social media network, a social graph, a non-username, non-password protected website, a datastore local to the mobile device, or a combination thereof.

In some embodiments, aggregating the plurality of data files includes searching a second plurality of data files accessed from at least one data source using predetermined searching criteria that bear a relationship to the subject of the contact record. One or more data files are retrieved based on the search. In some embodiments, the data files represent a plurality of data types, and the types of data may include text, photo, audio, video, or a combination thereof. In some embodiments, the first plurality of data files originate from at least one data source including at least one datastore including a contact record profile, email, SMS, photo files, music files, or a combination thereof. In some embodiments, aggregating the plurality of data files further includes storing the retrieved data files.

In some embodiments, the template includes associated instructions for incorporation of data into the video including instructions for the order of the data files of the plurality of data types to be incorporated in the video and the duration of play of each data file in the video. In some such embodiments, the instructions for incorporation of data into the video further include instructions for rendering a plurality of data files concurrently and/or for transitions between data files in the video.

In some embodiments, the processing device is further configured for storing the video in a local datastore in the mobile device, while in other embodiments the processing device is further configured for storing the video in a datastore on a server.

In accordance with another embodiment of the present invention, a computer program product for generating a video related to a subject of a contact record in a mobile device is provided. The computer program product includes a non-transitory computer readable medium including computer readable instructions, the instructions including instructions for aggregating a first plurality of data files originating from at least one data source. At least some of the data in the data files bears a relationship to the subject of the contact record. The instructions also include instructions for providing a predefined template for incorporation of data into the video, and instructions for merging data into a video according to the predefined template.

In some embodiments, the instructions further include instructions for saving the video as a video stream file for later rendering, and then instructions for accessing the video stream file and rendering the video in the mobile device. In other embodiments, the instructions further include instructions for rendering the video in the mobile device in real time as the data is merged into the video.

In some embodiments, the instructions further include instructions for rendering the video in the mobile device when the contact record is accessed, while in other embodiments the instructions further include instructions for rendering the video in the mobile device after the contact record is accessed and when a user instructs the video to be rendered.

In some embodiments, the instructions further include instructions for (1) prompting a user to provide input to identify a subject of the video based on either selecting from existing contact records or creating a new contact record and (2) receiving the user's input. In some embodiments, the non-transitory computer readable medium is in the mobile device, while in other embodiments the non-transitory computer readable medium is in a server remote from the mobile device.

In some embodiments, the at least one data source includes at least one of a social media network, a social graph, a non-username, non-password protected website, a datastore local to the mobile device, or a combination thereof. In some embodiments, the instructions for aggregating the first plurality of data files further include instructions for searching a second plurality of data files accessed from at least one data source using predetermined searching criteria that bear a relationship to the subject of the contact record, and instructions for retrieving one or more data files based on the search. In some such embodiments, the data files represent a plurality of data types, and the types of data may include text, photo, audio, video, or a combination thereof. In some embodiments, the first plurality of data files originate from at least one data source including at least one datastore including a contact record profile, email, SMS, photo files, music files, or a combination thereof. In some embodiments, the instructions for aggregating the first plurality of data files further include instructions for storing the retrieved data files.

In some embodiments, the template includes associated instructions for incorporation of data into the video including instructions for the order of the data files of the plurality of data types to be incorporated in the video and the duration of play of each data file in the video. In some such embodiments, the instructions for incorporation of data into the video further include instructions for rendering a plurality of data files concurrently. In other such embodiments, the instructions for incorporation of data into the video include instructions for transitions between data files in the video.

In some embodiments, the instructions further include instructions for storing the video in a local datastore in the mobile device, while in other embodiments the instructions further include instructions for storing the video in a datastore on a server.

### BRIEF DESCRIPTION OF THE DRAWINGS

For a more complete understanding, reference should now be had to the embodiments shown in the accompanying drawings and described below. In the drawings:

FIG. 1 is a front view of a mobile device displaying a contact video in accordance with embodiments of the present invention.

FIGS. 2A and 2B are a flowchart illustrating a method of providing a contact video in accordance with embodiments of the present invention.

FIG. 3 is an information flow diagram in accordance with embodiments of the present invention.

FIG. 4 is a block diagram of the mobile device of FIG. 1 in accordance with embodiments of the present invention.

FIG. 5 is a block diagram of a contact video generation environment in which various methods described herein are performed in accordance with embodiments of the present invention.

FIG. 6 is an object relationship diagram illustrating various types of information present in a contact video generation environment in accordance with embodiments of the present invention.

FIG. 7 is a process flowchart for an example generation of a contact video in accordance with embodiments of the present invention.

FIG. 8 is a schematic view of a complete contact video in accordance with embodiments of the present invention.

FIG. 9 is a sample predefined template for contact video generation in accordance with embodiments of the present invention.

### DESCRIPTION

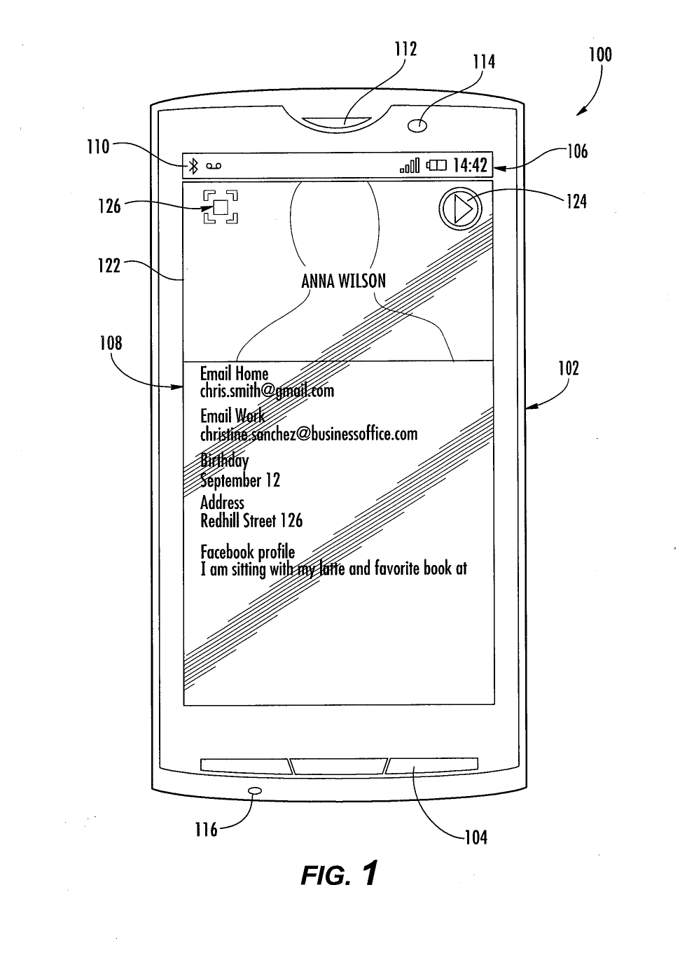

Referring now to the drawings, wherein like reference numerals designate corresponding or similar elements throughout the several views, an embodiment of a mobile device 100, in this case a Smartphone, is shown in FIG. 1. Mobile device 100 includes a housing 102, operation control buttons 104, a screen 106, a display area 108 of the screen 106, a status bar area 110 of the screen 106, a speaker 112, a camera 114, and a microphone 116. In the display area 108, the mobile device 100 is shown in the mode of displaying a contact record. The contact record, in this embodiment, includes text data 120 of home and work email addresses, birthday, physical address, and current status of a Facebook® profile. In addition, an initial display of a video 122 for this contact record is shown at the top of the display area 108. The contact video may alternatively be located elsewhere in the display area 108, or may take up the entire display area. The video may start automatically upon access of the contact record, or alternatively, a “play” button 124, that may toggle to display a “pause” button, may provided in the display area to start the video, along with a “stop” button 126.

As used herein, the term “mobile device” may include apparatus including, but not limited to: a portable digital assistants (PDAs) or Smartphones that may include, for example, a radiotelephone, pager, Internet/intranet access, Web browser, organizer, calendar and/or a global positioning system (GPS) receiver; a palmtop receiver or other appliance; a hand held phone; a Personal Communications

System (PCS) terminal that may combine a cellular radiotelephone with data processing, facsimile and data communications capabilities; gaming devices, including handheld games or controllers; a personal music playback system such as for CDs, minidisks, MP-3 files, memory sticks, or the like; a laptop computer; a Netbook; a tablet computer, for example, an iPad; and any handheld or portable device where a contact list, phonebook, or the like is a feature.

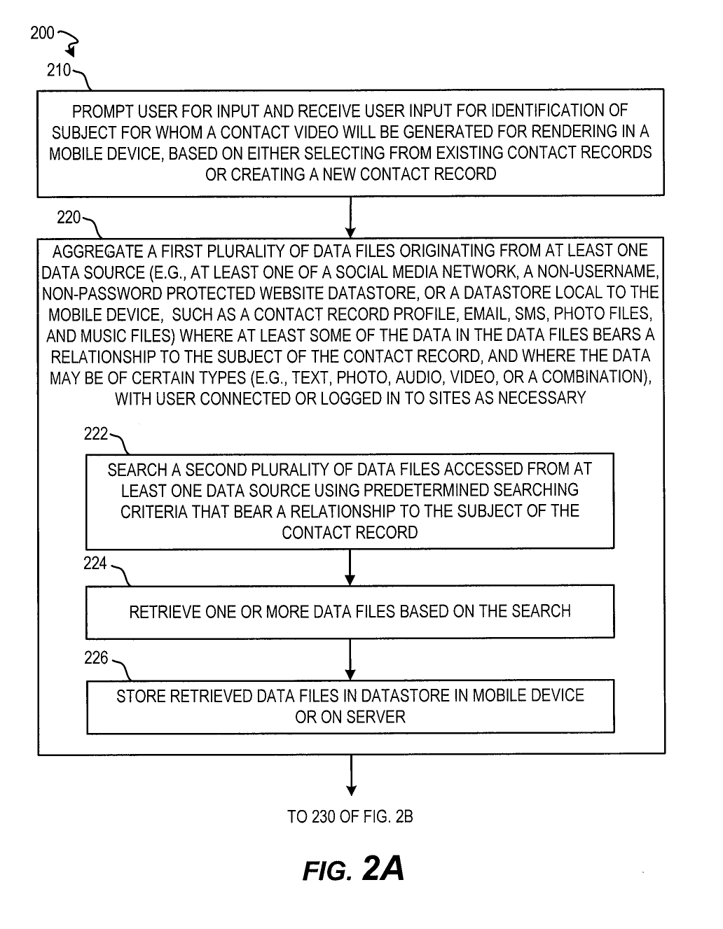

FIGS. 2A and 2B illustrate an embodiment of a method 200 for contact video generation. A contact video 122 may be considered to be an informative and entertaining way to describe people in mobile devices 100. In the first step, as represented by block 210, a user is prompted for input and input is received from the user regarding identification and selection the subject of the contact record for whom a contact video is to be generated for rendering in a mobile device, and on whom retrieval of information will be based. Such a selection may be done, for example, by selecting from existing contact records or creating a new contact record. The next step, as represented by block 220, is to aggregate a first plurality of data files originating from at least one data source. A data source may be, for example, (1) a social media network including a social media repository, (2) a social graph, (3) a non-username, non-password protected website datastore, or (4) a datastore local to the mobile device 100. Datastores local to the mobile device 100 may include data from contact record profiles, email, SMS, photo files, and music files. The data may represent various types of information such as text, photo, audio, and/or video related to the subject of a contact record in the mobile device 100.

Aggregating data files 220 in one embodiment may also include several steps, starting with searching a second, larger plurality of data files 222 that are accessed from at least one data source using predetermined searching criteria. The searching criteria may bear a relationship to the subject of the contact record. Data files are then retrieved 224 based on the search. In some embodiments, data, which may in some cases be considered social information, is downloaded from one or more social media systems. Accordingly, the social information to be retrieved 220 may be reached from a local datastore on the mobile device 100, on a non-username, non-password protected Internet server, or on a username and password protected Internet server. For protected servers, a user may login with use of a device keychain or with manual input of username and password to access the information. The data may be, for example, in the form of data files that are acquired through specific keyword searches. The data in some embodiments may then be stored 226 in a datastore that is in the mobile device 100 or on a server remote from the mobile device 100.

The next step, represented by block 230, is to initiate or access a predefined template that dictates the structure and timing of the video. For example, the template may include instructions for the types of data to go into the video, the sources of the information, the order in which the data is to be used, display features, transitions between data, concurrent rendering of different data, and time segments or duration for data rendering and transitions. The template may be a predefined set of “screens” and transitions, in one embodiment effectively being a script for the video with empty placeholders to be filled with content from the aggregated files. In one embodiment, instructions may be provided in one file, with a template provided in a separate data file.

At block 240, the data is merged into a file according to the predefined template and instructions for merging the data. Video rendering is enabled at step 250, which may occur in one of at least two ways. In one approach, at block 252 the video, which may be considered a customized video stream, may be stored as a file in a datastore either in the mobile device 100 or on a remote server. The video may be accessed 254 and then streamed 256 to the mobile device 100, where the video is rendered 260. Alternatively, instead of saving the merged video file 252, the video may be streamed in real time 258 in an on-demand function where the video is immediately rendered 260. The user of the mobile device 100 may need to connect and/or log in to the server to access the video stream, at which time the video stream may be downloaded to the mobile device 100.

Rendering the video 260 may be done, for example, automatically when the contact record is accessed by a user or after the contact record is accessed by the user and the user directs the video to be played by pressing the “play” button 124.

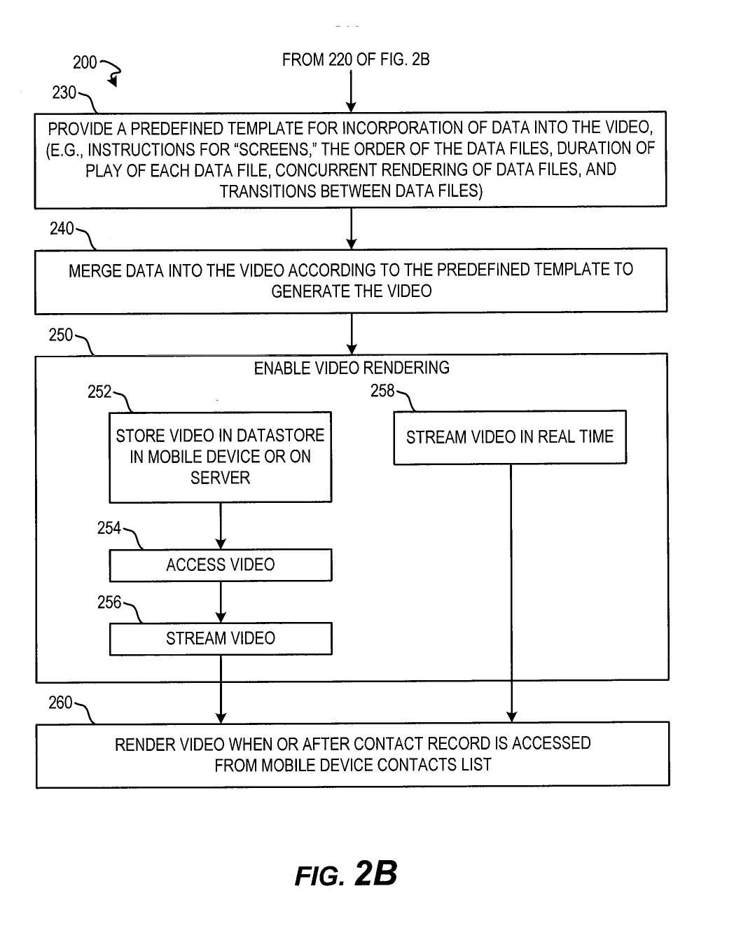

FIG. 3 shows an information flow diagram 300 with the various sources for data, specifically local data 302 for a selected contact record for “Person X” and the Person X online profiles and cloud content 304, as they are merged 240 into a customized video stream 306 for Person X. Although the subject of a contact record may be referred to herein as a person, “Person X” and other subjects of contact records described herein may be any entity for which a contact record may be established, for example companies, stores, groups, agencies, teams, and so forth. Sources for local data 302 include, for example, the contact record profile content 308, SMS records 310 including text messages and photos, emails 312, saved photos 314, music 316, and other data 318 saved in memory or a datastore. Contact record profile content 308 may include, for example, information such as first name, last name, birth date, city, or other metadata that may be stored in the local address book, phone book, or contacts list profile. SMS record 310 may include, for example, text messages sent to or received by Person X. Photos 314 may include, for example, locally stored images that have pictures tagged with Person X, or photos of Person X identified by facial recognition software. Music 316 may be retrieved based on identification of what types of music, songs, or artists Person X “is listening to,” “likes,” or “is a fan of” based on information from online profiles and cloud content 304.

Online profiles and cloud content 304 may include, with respect to online profiles, social media networks such as Facebook®, Twitter®, Flickr®, Linked-in®, YouTube®, and the like, as well as, for relationship information, social graphs through Application Programming Interfaces (APIs) such as Facebook® Graph API and Google® Social Graph API. Cloud content may also include data present anywhere on the World Wide Web. Social media networks and social graphs, which to some extent require a user to login in order to have full access, and other sites, such as Wikipedia, which require only a connection, may fill the roles of Service A 320, Service B 322, and additional other services 324.

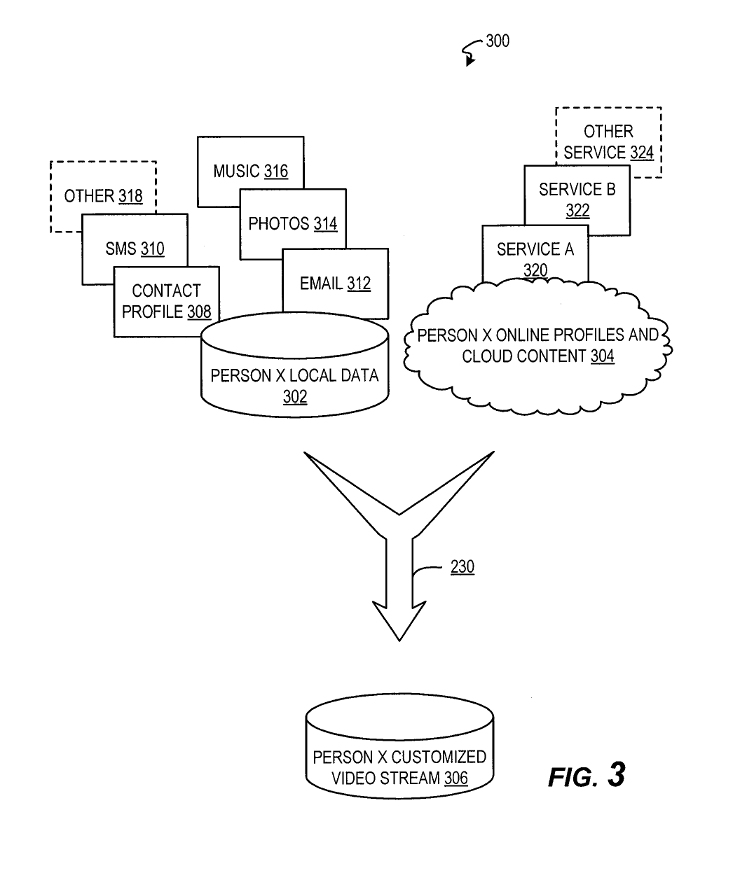

FIG. 4 provides a block diagram illustrating the consumer mobile device 100 of FIG. 1 in more detail, in accordance with embodiments of the invention. In one embodiment of the invention, the mobile device 100 is a Smartphone. However, it should be understood, however, that a Smartphone is merely illustrative of one type of mobile device 100 that may benefit from, employ, or otherwise be involved with embodiments of the present invention and, therefore, should not be taken to limit the scope of embodiments of the present invention.

The mobile device 100 generally includes a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally includes circuitry for implementing communication and/or logic functions of the mobile device 100. For example, the processor 410 may include a digital signal processor device, a microprocessor device, and various analog to digital converters, digital to analog converters, and/or other support circuits. Control and signal processing functions of the mobile device 100 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 421. The web browser application 421 may then allow the mobile device 100 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on a network. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively.

The signals may include signaling information in accordance with the air interface standard of the applicable cellular system of a wireless telephone network. In this regard, the mobile device 100 may be configured to operate with one or more air interface standards, communication protocols, modulation types, and access types. By way of illustration, the mobile device 100 may be configured to operate in accordance with any of a number of first, second, third, and/or fourth-generation communication protocols and/or the like. For example, the mobile device 100 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 100 may also be configured to operate in accordance with non-cellular communication mechanisms, such as via a wireless local area network (WLAN) or other communication/data networks.

As described above, the mobile device 100 has a user interface that is, like other user interfaces described herein, made up of user output devices 436 and/or user input devices 440. The user output devices 436 include a display 106 (e.g., a liquid crystal display or the like) and a speaker 112 or other audio device, which are operatively coupled to the processor 410. The user input devices 440, which allow the mobile device 100 to receive data from a user, may include any of a number of devices allowing the mobile device 100 to receive data from a user, such as a keypad, keyboard, touch-screen, touchpad, microphone, mouse, joystick, other pointer device, button, soft key, and/or other input device(s). The user interface may also include a camera 480, such as a digital camera.

The mobile device 100 may also include a positioning system device 475 that is configured to be used by a positioning system to determine a location of the mobile device 100. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate location of the mobile device 100. In other embodiments, the positioning system device 475 includes a proximity sensor or transmitter, such as an RFID tag, that can sense or be sensed by devices known to be located proximate a merchant or other location to determine that the consumer mobile device 100 is located proximate these known devices.

The mobile device 100 further includes a power source 415, such as a battery, for powering various circuits and other devices that are used to operate the mobile device 100. Embodiments of the mobile device 100 may also include a clock or other timer 450 configured to determine and, in some cases, communicate actual or relative time to the processor 410 or one or more other devices.

The mobile device 100 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which include computer-executable instructions/code executed by the processor 410 to implement the functions of the mobile device 100 described herein. For example, the memory 420 may include such applications as a conventional web browser application 421, an SMS application 422, and email application 423, a photo application 424, a music application 425, and a contact video application 426. These applications also typically provide a graphical user interface (GUI) on the display 106 that allows the user to communicate with other devices or systems. In one embodiment of the invention, when the user decides to acquire the contact video application 426, the user downloads or otherwise obtains the contact video application 426 from an application server. In other embodiments of the invention, the user interacts with the contact video application via the web browser application 421 in addition to, or instead of, the contact video application 426 stored in the memory 420 of the mobile device 100.

The memory 420 can also store in a datastore 490 any of a number of pieces of information, and data, used by the mobile device 100 and the applications and devices that make up the mobile device 100 or are in communication with the mobile device 100 to implement the functions of the mobile device 100 and/or the other systems described herein. For example, the memory 420 may include such data as text, photos, audio, and/or video for use in the contact video application 426, as well as the predefined template to be accessed by the contact video application 426 for merging information and content into a video.

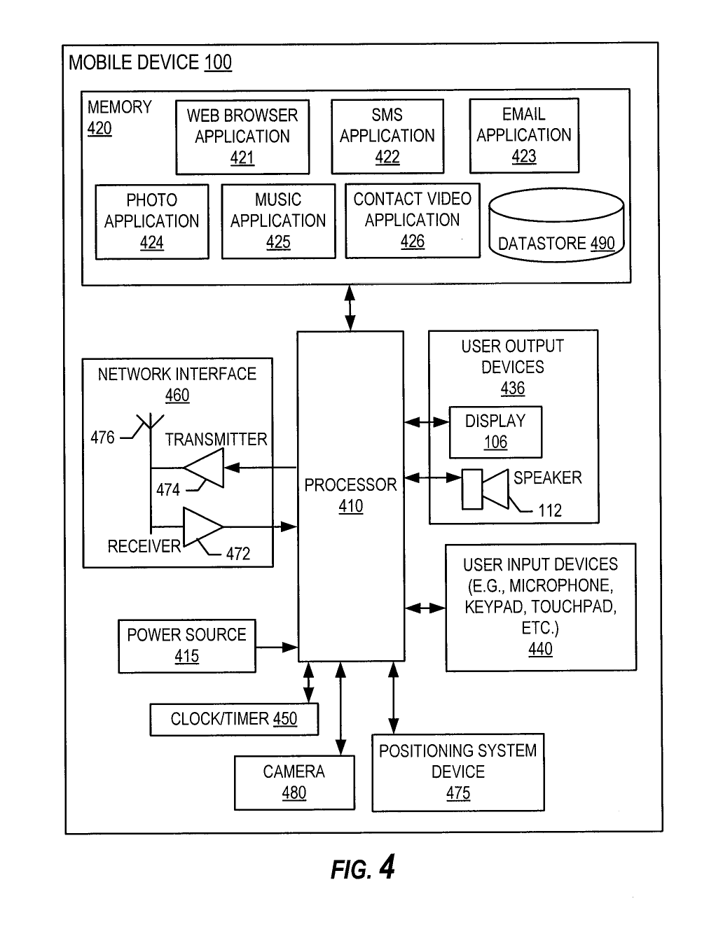

Referring now to FIG. 5, a block diagram of a contact video generation environment 500 in which the various methods described herein are performed is shown according to embodiments of the present invention. A user 502 operates a mobile device 400 that may communicate through a network 504 with one or more resource systems 506 and, in some embodiments, with an application system 508. The resource system 506 is a computer system, server, multiple computer systems and/or servers or the like.

The resource system 506, in the embodiments shown has a communication device 512 communicably coupled with a processing device 514, which is also communicably coupled with a memory device 516. The processing device is configured to control the communication device 512 such that the resource system 506 communicates across the network 504 with one or more other systems. The network 504 may include a local area network (LAN), a wide area network (WAN), and/or a global area network (GAN). The network 504 may provide for wireline, wireless, or a combination of wireline and wireless communication between devices in the network. In one embodiment, the network 504 includes the Internet. In one embodiment, the network 504 includes a wireless telephone network 520.

The processing device 514 is also configured to access the memory device 516 in order to read the computer readable instructions 522, which in some embodiments include one or more social media applications 524 for instructing the processing device 514 for providing the social media service to the various users, and/or general website applications 526. The resource system 506 and social media applications 524 are configured for providing a social media service to people. For example, one or more resource systems 506 are configured for pushing social media content onto the Internet and receiving input from millions of users in a wide variety of formats. The memory device 516 also has a datastore 528 or database for storing pieces of data for access by the processing device 514, such as, for example, data regarding the users having profiles within the social media service.

An application system 508 is configured for downloading of the contact video application 426 to the mobile device 100 in some embodiments. The application system 508 is a computer system, server, multiple computer system, and/or multiple servers or the like. The application system 508 has a communication device 532 communicatively coupled with a processing device 534, which is also communicatively coupled with a memory device 536. The processing device 534 is configured to control the communication device 532 such that the application system 508 communicates across the network 504 with one or more other systems. The processing device 534 is also configured to access the memory device 536 in order to read the computer readable instructions 538, which in some embodiments include a contact video application 540 if the contact video generation is done on the application system 508 rather than the mobile device 100. The memory device 536 also has a datastore 542 or database for storing pieces of data for access by the processing device 534 or for storing the contact video application 426 for download to the mobile device 100.

In various embodiments, one or more of the systems discussed above, such as the resource system 506 or the application server 508, is more than one system and the various components of the system are not collocated, and in various embodiments, there are multiple components performing the functions indicated herein as a single device. For example, in one embodiment, multiple processing devices perform the functions of the processing devices 514, 534 of the resource system 506 or the application server 508 described herein, respectively.

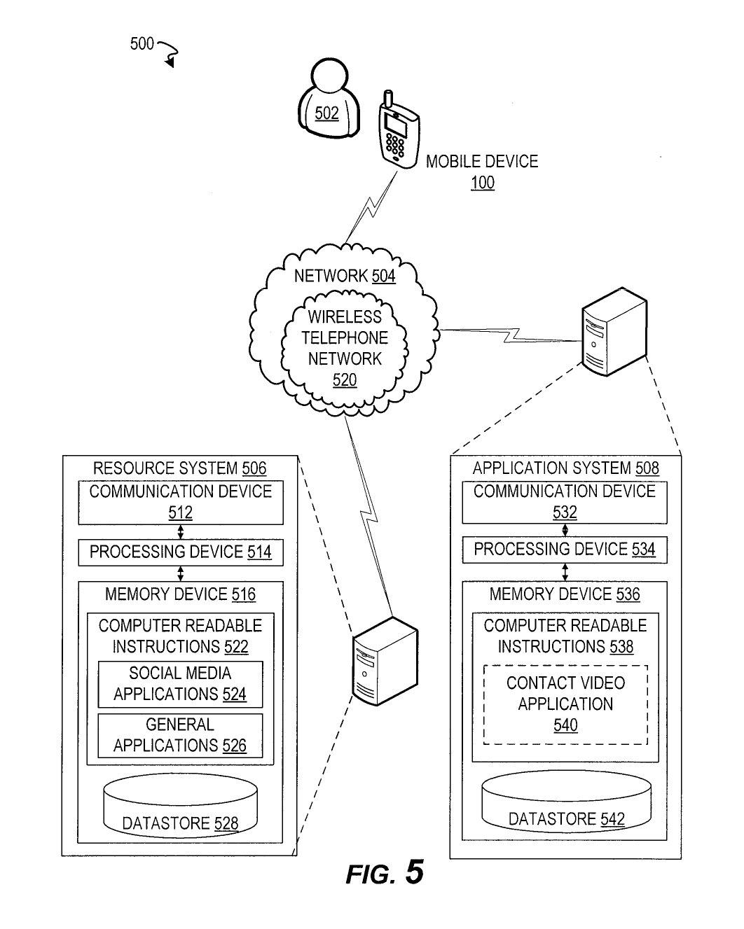

FIG. 6 shows various types of content 600 and how their relationships may develop search results including social information about a person in a contact record. Three broad categories of information content are diagramed: Person X information/text 602, Person X profile-connected multimedia 604, and Person X non-profile related multimedia 606. The content may be retrieved from sources identified in FIG. 3.

Person X information/text 602 may include entries such as the person's name 610, latest status update 611, time of day at the location of the person, the person's current location, the country of residence of the person 614, the birthday and/or age 615 of the person, the person's spouse 616, closest friends 617, children 618, latest recommended music 619, and latest “tweet” 620 on Twitter®. Person X profile-connected multimedia 604 may include audio content 630, photo content 631, and video content 632, which may be, for example, recorded audio, profile pictures or shared photos, or video footage, as may bear a relationship with the person that could be set out in the person's profile page. Person X non-profile related multimedia 606 may also include audio content 640, photo content 641, and video content 642, such as ambient backgrounds or location images, like maps or photos of a location.

Content extraction may be performed from the various sources identified in Person X local data 302 and Person X online and cloud content 304 by use of the relationships between different information, with the search 650 and retrieval 651 to and from Person X information/text 602 and Person X profile-connected multimedia 604, as well as search 652 and retrieval 653 to and from Person X information/text 602 and Person X non-profile related multimedia 606. For example, data naming children 618 could be used to search for photos 631 of the children in which the children are tagged in Person X profile-connected multimedia 604, or, if associated with a photo, to use facial recognition software to identify the children where photos 621 are not tagged. Person X's residential country 614 could be used to extract content from Person X non-profile related multimedia 606, such as pictures of the home country. Latest recommended music 619 could allow a retrieval of audio for a song from Person X non-profile related multimedia 606. All of the information 600 in FIG. 6 is non-limiting examples of data that bear a relationship to the subject of the contact record, Person X.

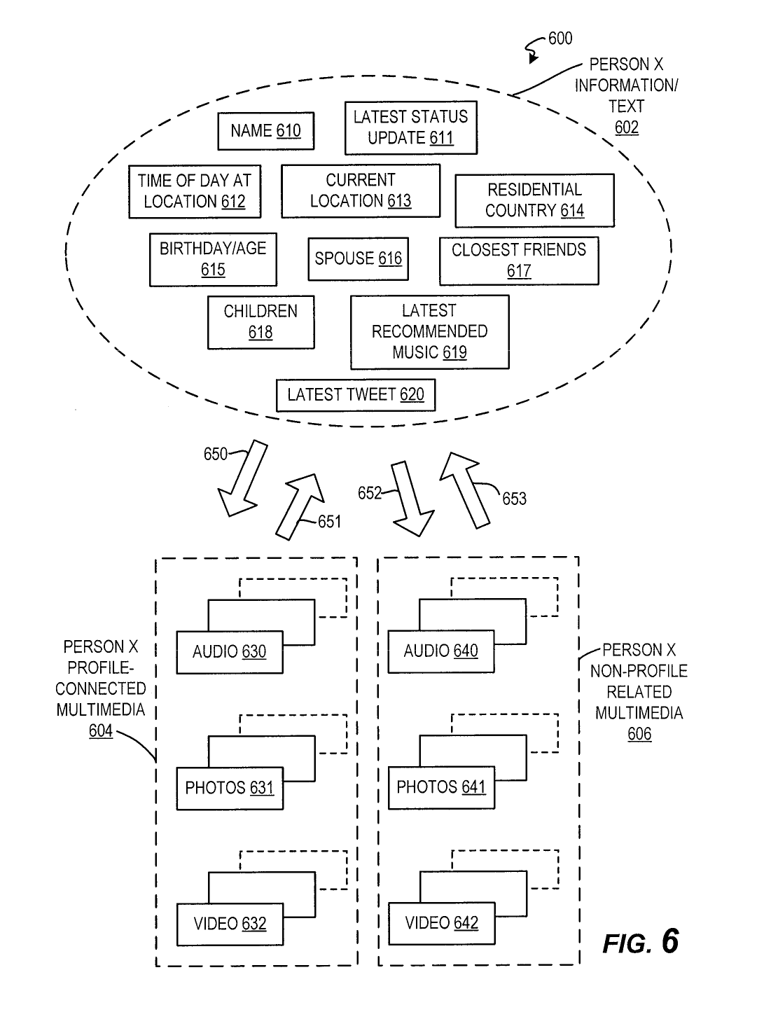

FIG. 7 illustrates a simplified flow of the process for generating a contact video 700. The contact record may identify the closest friends 617 of the user 502, who in this example are Person Y and Person Z. The contact video application 426 may search for and retrieve images 702 in which Person Y and Person Z are tagged, providing raw content 704 of an image of Person Y 706 and an image of Person Z 708. Then, using a predefined template 710 a contact video 712 is generated, as described with respect to FIG. 2; in this case the video could, for example, be rendered both when the contact record for Person Y is accessed and when the contact record for Person Z is accessed. The contact video 712 may be considered a video clip, might have an opening image 714 that says “My Closest Friends” and list the friends' names, and then play the video incorporating the raw data content 704.

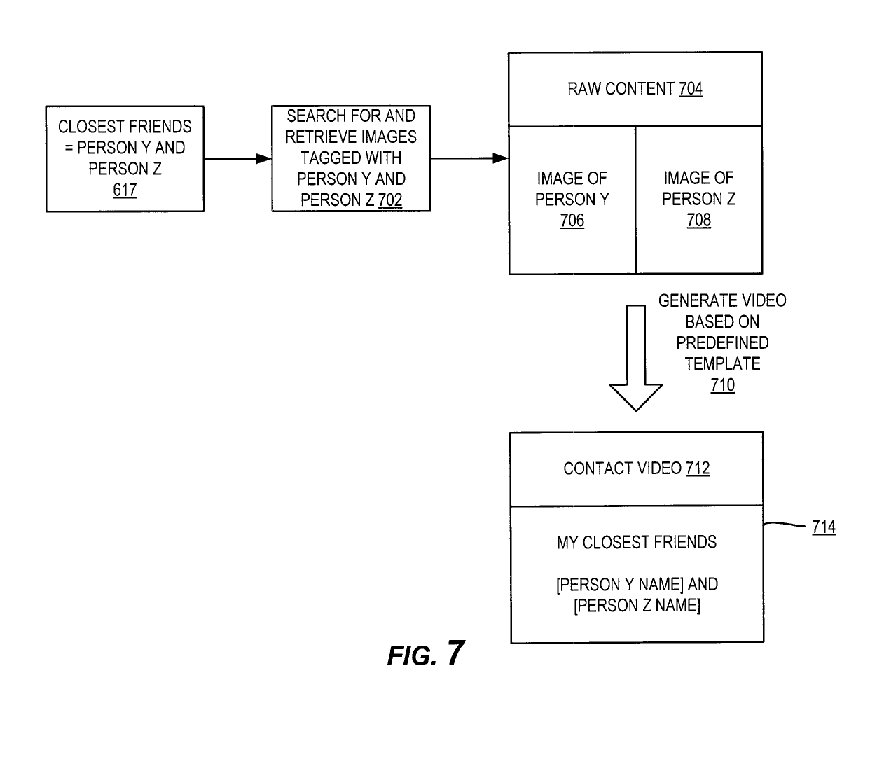

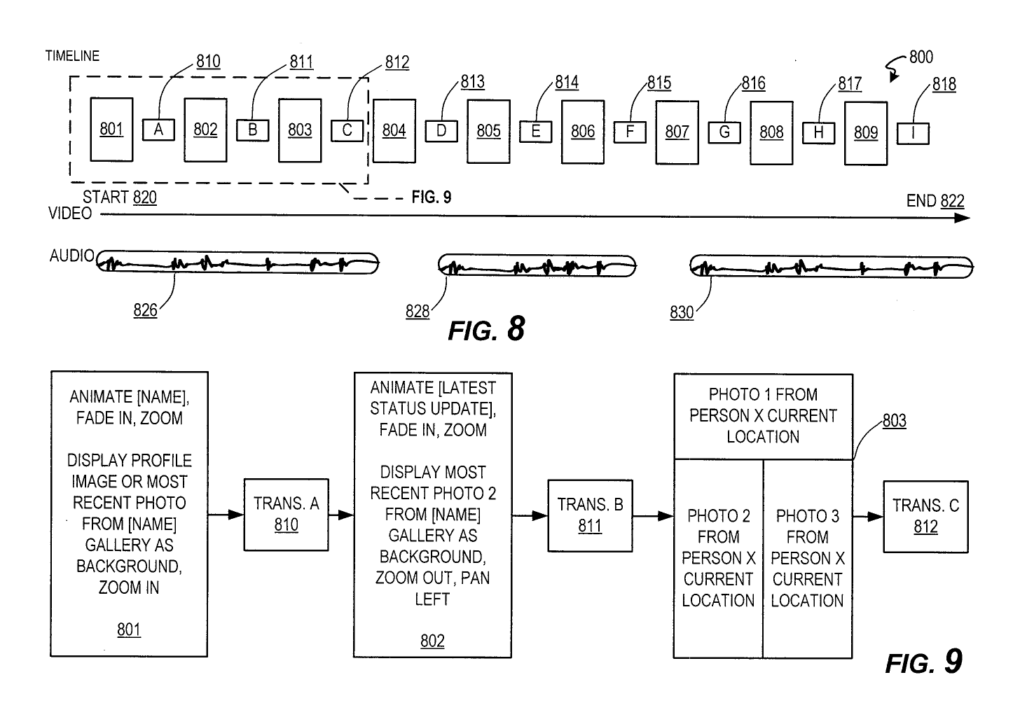

FIGS. 8 and 9 illustrate the template and rendering of a contact video or video clip 800 in a timeline. The video clip 800 includes video content segments 801-809 and transitions A-I 810-819. The video starts 820 on the left of the figures and ends 822 at the right side of FIG. 8. The video clip 800 may include both video and audio portions 826, 828, 830, which may overlap a plurality of video content segments 801-809 and transitions A-I 810-818 and accordingly a plurality of data files are rendered concurrently. The transitions may be provided using a process known to those of ordinary skill in the art as “tweening.” FIG. 9 shows the first three video content segments 801, 802, 803 followed by transition A 810, transition B 811, and transition C 812, respectively. In the opening video content segment 801, a person's name is animated and treated with a fade-in and zoom manipulation, with the profile image or most recent photo from the person's gallery as background, and a zoom-in. After transition A 810, the second video content segment is rendered, in which the person's latest status update is animated and treated with a fade-in and zoom manipulation, with the second most recent photo from the person's gallery as background, and a zoom-out and pan left manipulation. After transition B 811, three photos may be shown simultaneously, that in this example are photos 1, 2, and 3 from the current location of Person X. Although only photos are referred to in the video content segments 801-803, it is understood that any type of visual content could used, whether it be still photo, video, or text.

Although only a few exemplary embodiments have been shown and described in considerable detail herein, it should be understood by those skilled in the art that we do not intend to be limited to such embodiments since various modifications, omissions and additions may be made to the disclosed embodiments without materially departing from the novel teachings and advantages, particularly in light of the foregoing teachings. Accordingly, we intend to cover all such modifications, omission, additions and equivalents as may be included within the spirit and scope as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

1. A method for generating a video related to a subject of a contact record in a mobile device, the method comprising:
aggregating a first plurality of data files originating from at least one data source, wherein at least some of the data in the data files bears a relationship to the subject of the contact record;
providing a predefined template for incorporation of data into the video; and
merging data into a video according to the predefined template.

2. The method of claim 1, further comprising saving the video as a video stream file for later rendering.

3. The method of claim 2, further comprising accessing the video stream file and rendering the video in the mobile device.

4. The method of claim 1, further comprising rendering the video in the mobile device in real time as the data is merged into the video.

5. The method of claim 1, further comprising rendering the video in the mobile device when the contact record is accessed.

6. The method of claim 1, further comprising rendering the video in the mobile device after the contact record is accessed and when a user instructs the video to be rendered.

7. The method of claim 1, further comprising, in advance of aggregating the first plurality of data files:
prompting a user to provide input to identify a subject of the video based on either selecting from existing contact records or creating a new contact record; and
receiving the user's input.

8. The method of claim 1, wherein at least one of aggregating a plurality of first data files, providing a template, and merging data is performed in the mobile device.

9. The method of claim 1, wherein at least one of aggregating a plurality of first data files, providing a template, and merging data is performed in a server remote from the mobile device.

10. The method of claim 1, wherein the at least one data source comprises at least one of a social media network, a social graph, a non-username, non-password protected website, a datastore local to the mobile device, or a combination thereof.

11. The method of claim 10, wherein aggregating the first plurality of data files further comprises:
searching a second plurality of data files accessed from at least one data source using predetermined searching criteria that bear a relationship to the subject of the contact record, and
retrieving one or more data files based on the search.

12. The method of claim 11, wherein the data files represent a plurality of data types.

13. The method of claim 12, wherein the types of data comprise text, photo, audio, video, or a combination thereof.

14. The method of claim 10, wherein the first plurality of data files originates from at least one data source comprising at least one datastore including a contact record profile, email, SMS, photo files, music files, or a combination thereof

15. The method of claim 10, wherein aggregating the plurality of data files further comprises storing the retrieved data files.

16. The method of claim 1, wherein the template includes associated instructions for incorporation of data into the video that comprise instructions for the order of the data files of the plurality of data types to be incorporated in the video and the duration of play of each data file in the video.

17. The method of claim 16, wherein the instructions for incorporation of data into the video further comprise instructions for rendering a plurality of data files concurrently.

18. The method of claim 16, wherein the instructions for incorporation of data into the video comprise instructions for transitions between data files in the video.

19. The method of claim 1, further comprising storing the video in a local datastore in the mobile device.

20. The method of claim 1, further comprising storing the video in a datastore on a server.

21. A contact video generation system comprising:
a processing device configured for:
aggregating a first plurality of data files originating from at least one data source, wherein at least some of the data in the data files bears a relationship to the subject of the contact record;
providing a predefined template for incorporation of data into the video; and
merging data into a video according to the predefined template.

22-40. (canceled)

41. A computer program product for generating a video related to a subject of a contact record in a mobile device, the computer program product comprising a non-transitory computer readable medium comprising computer readable instructions, the instructions comprising:
instructions for aggregating a first plurality of data files originating from at least one data source, wherein at least some of the data in the data files bears a relationship to the subject of the contact record;
instructions for providing a predefined template for incorporation of data into the video; and
instructions for merging data into a video according to the predefined template.

42-60. (canceled)
